(19) United States
(12) Patent Application Publication
(10) Pub. No.: US 2016/0075575 A1
(43) Pub. Date: Mar. 17, 2016

(54) SPECIAL PALLADIUM CATALYST FOR SEWAGE TREATMENT AND USE THEREOF

(71) Applicant: NANJING DELEI SCIENCE & TECHNOLOGY CO., LTD, Nanjing (CN)

(72) Inventor: Hao Wu, Nanjing (CN)

(73) Assignee: NANJING DELEI SCIENCE & TECNOLOGY CO., LTD., Nanjing (CN)

(21) Appl. No.: 14/888,866

(22) PCT Filed: Apr. 28, 2014
(86) PCT No.: PCT/CN2014/076319

§ 371 Date: Nov. 3, 2015

(30) Foreign Application Priority Data
May 3, 2013 (CN) 201310160589.7

(51) Int. Cl. C02F 1/72; C02F 1/78; B01J 23/50; C02F 1/74; B01J 23/89; B01J 23/44

(52) U.S. Cl. CPC C02F 1/725; B01J 23/8906; B01J 23/44; B01J 23/50; C02F 1/74; C02F 1/78; C02F 2101/30

(57) ABSTRACT

A special palladium catalyst for sewage treatment includes a stainless steel carrier, and a metal palladium layer uniformly distributed on the surface of the stainless steel carrier. A thickness of the palladium layer is 1 nm-5 μm. A preparation method and use of the special palladium catalyst for sewage treatment includes contacting sewage with a palladium catalyst described above.

### TECHNICAL FIELD

The present invention relates to the field of environmental protection technology, specifically relates to a palladium catalyst for sewage (wastewater) treatments and the uses thereof.

### BACKGROUND

A conventional sewage (wastewater) treatment process involves the following: passing the discharged sewage through a sedimentation pool, a horizontal flow pool, a filtration device, a concentration pool, and a sludge water separation device to complete the treatment process. Chinese Patent Application Publication No. CN 1100070A discloses a method for sewage treatment. An oxygenation pond is set up near an ocean and divided into an aerobic area, an anaerobic area and an aerobic-anaerobic concurrent area, wherein toxic materials in the wastewater are digested by microbes. After the treatment, the wastewater may be pumped from the oxygenation pond into the ocean. The digested products and particulates settle to the bottom of the pond. The requirements for the terrain and climate in using such a technology are high. Therefore, this technology is not suitable for widespread applications. Chinese Patent Application Publication No. CN 101574595A discloses a water treatment equipment that primarily solves the problem of separation of wastewater and sludge. Chinese Patent Application Publication No. CN102160943A discloses a wastewater treatment machine that uses a mechanical vibration sieve to remove contaminants in wastewater. Chinese Patent Application No. CN102515415A discloses a water treatment vehicle, using a primary aerobic pool, a secondary aerobic pool, and a sedimentation tank to treat household wastewater in country side.

The problems with the existing sewage treatment technologies include: the facility occupying a large area; construction of such facilities being expensive; the facilities requiring a substantial capital investment; and high operational expense. These factors limit the widespread adoption of these technologies. In addition, with the existing technologies, degradation and treatment of toxic materials are incomplete. They cannot sufficiently solve the problems of sewage detoxification and deodorization, as well as the degradation and removal problems of organic contaminant.

### SUMMARY OF THE INVENTION

A technical problem addressed by the present invention is to provide palladium catalysts for sewage (also referred to as “wastewater”) treatment, which can provide most efficient treatments of various sewage.

Another technical problem addressed by the present invention is to provide applications of the above-described catalysts.

To solve these technical problems, the present invention provides the following technical solutions:

A palladium catalyst for use in wastewater treatment, characterized in that it has a stainless steel carrier (or support) on whose surface is evenly distributed the palladium metal atom.

Wherein the thickness of palladium layer is 1 nm-5 μm.

Wherein the palladium layer may also contains silver. The weight content of silver is 0.001%-45% wt. of the palladium.

A method for preparing a palladium catalyst for use in wastewater treatment is to use chemical precipitation in order to make palladium metal evenly adhere to the stainless steel carrier.

The chemical precipitation method comprises: under a specific condition, adding an appropriate reductant (e.g., hydrazine, sodium hypophosphite) into a solution containing palladium ion in order to reduce the palladium ion to palladium atom which adhering to the surface of stainless steel and forming a palladium film over there. Alternatively, adding an appropriate reductant (e.g., hydrazine, sodium hypophosphite, glucose) into a solution containing palladium and silver ions in order to reduce the palladium and silver ions to atoms which form a layer of palladium-silver alloy over the surface of stainless steel. The above-described solutions are that contain an agent (such as citric acid, ammonia water) that capable of forming stable clathrate complex with palladium and silver ions. The solution is of pH 6-10 and controlled at 50-80° C. The time required for forming the palladium film or palladium-silver film is normally 1-8 hours.

The applications of the palladium catalyst in the treatments of wastewater.

Wherein the treatable wastewater is of pH 6-14, wherein pH >9 would produce better results. The wastewater include printing and dyeing wastewater, paper-making wastewater, slaughter house wastewater, tannery wastewater, chemical fiber plant wastewater, food processing plant wastewater, petroleum/chemical plant wastewater, polyvinyl alcohol containing wastewater, nonferrous metallurgy wastewater, coking wastewater, coal chemical plant wastewater, electroplating and other surface treatment waste water, amine treatment plant wastewater, MBR wastewater, non-attained wastewater from biochemical treatment plant, sludge-containing wastewater from biochemical treatment plant, foul smelling wastewater, industrial wastewater containing less than 100 ppm halogen, municipal wastewater, landfill seepage wastewater, biochemical pharmaceutical plant wastewater, wastewater containing plasticizer, pesticides and cyanide, wastewater from large-area organically-polluted and eutrophicated rivers and lakes, and industrial circulating water.

The specific procedure is as follows: use stainless steel as the material of wastewater treatment container, on whose inner surface is evenly distributed an above-described palladium film. Then, thoroughly mix the wastewater and ozone-containing oxygen or ozone-containing air before introducing into the treatment container. Mix or circulate the wastewater in order to make the wastewater sufficiently contact the catalyst. Thus the wastewater is simultaneously deodorized, decolorized and organically degraded under the action of the catalyst. The degradation of organics makes it easier and more complete to precipitate the heavy metal and solids, while decreasing the chemical oxygen demand (COD) of the wastewater and thereby increasing the ratio of biochemical oxygen demand (BOD) to COD, along with increasing the biodegradability.

Wherein, the content ratio of ozone to the total volume of ozone-containing oxygen or ozone-containing air is 10-160 mg/L. And the volume ratio of to-be-treated wastewater and ozone-containing oxygen or ozone-containing air is from 10:0.3 to 10:8.

According to the work flow of wastewater treatment, namely, circulation treatment or direct passage treatment, technicians should determine the amount of ozone to be mixed into and the amount of wastewater to be treated per unit time in large-scale wastewater treatment based on results of small-scale test and by analyzing the varieties of main contaminants in wastewater, the COD index of wastewater, and the required level of final-discharged treated water.

The optimization method is as follows: Addition of accessory parts as stainless steel baffles, interlayers, or pipes inside the treatment container, and evenly distributing the above-described Palladium films over the surfaces of these accessory parts, in order to make to-be-treated wastewater fully contact with catalyst during the reaction process. These stainless steel accessory parts could be integrally formed with the treatment container before distributing palladium atom films over both the container inner surfaces and surfaces of the accessory parts.

The ozone-containing oxygen or ozone-containing air comes into the reaction container (treatment container) and mixes with to-be-treated wastewater, then the reaction of ozone and water takes place under the action of catalyst and produces hydroxyl radical, which has extremely strong oxidizability. Thus indiscriminate oxidizing reactions happen between hydroxyl radical and organic matters, achieving full-scale degradation of organic matters.

On account of the closed environment, the ozone in the injected air or oxygen can not emerge from wastewater and is always kept contact with the catalyst, therefore the above-described catalytic oxidation reaction take place continuously in the wastewater. It greatly increases the use efficiency of ozone and hence decreases the costs of wastewater treatments. Even if unconsumed ozone disintegrates into oxygen in the closed catalytic environment, after entering the wastewater pool, the so-produced oxygen will continue to decrease COD without producing any adverse effects to the environment or deactivating the bacteria in wastewater pool during subsequent treatment. Furthermore, in the biochemical treatment pool, the so-produced oxygen can be added into dissolved oxygen, which is helpful to the activity of aerobic bacteria.

Beneficial effects: as an invention, the introducing methods have the following advantages, comparing with existing technologies:

(1) Low operational costs. According to the wastewater flow and environment indicators, degrade efficiently macromolecule organic matters by catalytic oxidation. It can sharply reduce the pressure and costs of subsequent wastewater treatment.

(2) Favorable decontamination effects. This invention changes the conventional approach that requires pre-separation prior to treatments. Instead, sludge and wastewater are intensively mixed into catalytic oxidation. Such process can degrade toxic and harmful matters, disintegrate the complex materials into simple harmless small molecules. For example, the PVA and COD in paper mill wastewater can be reduced by 100% and 95% respectively.

(3) Effective deodorization. The amount of ozone and air can be determined according to wastewater flow and environment indicators. Then the source of foul smell in the wastewater can be completely eliminated by designing a matching reactor and ensuring an appropriate duration for the wastewater reacting in closed system.

(4) Effective decolorization. Most wastewater present dark black color, especially the printing and dyeing plant wastewater. After the treatments of the introducing methods, wastewater can return to the color of natural water.

### BRIEF DESCRIPTION OF THE DRAWINGS

FIG. 1 shows results of X-ray fluorescence tests of a palladium catalyst prepared according to the first embodiment.

FIG. 2 shows results of X-ray fluorescence tests of a palladium catalyst prepared according to the second embodiment.

FIG. 3 shows photographs of treatment results according to embodiment 3. From left to right, these photographs are: prior to treatment, after ozone treatment (results from B container treatment), and after ozone catalytic treatment (results from A container treatment).

FIG. 4 shows a chart illustrating the COD changes during wastewater treatment according to embodiment 11.

### DETAILED DESCRIPTION

Embodiments of the invention can be better understood based on the Examples described below. However, one skilled in the art would appreciate that these Examples are used to illustrate embodiments of the invention and should not be used to limit the scopes of the invention, which are set forth in the appended claims.

### Example 1

### Preparation of Palladium Catalysts

Clean a stainless steel plate having a surface area of 1 m² with tap water, followed with chemical treatments to degrease, tap water rinse, activation by washing with an acid, and then wash with pure water. Using a chemical precipitation method, make palladium evenly adhere to the surface of the stainless steel. Then, it is washed with tap water and dried to obtain a palladium catalyst.

Wherein the chemical used in degreasing has the following compositions (wt %): 4 wt % NaOH, 4 wt % Na₃PO₄, 3 wt % Na₂CO₃, and water makes up the remaining of 100%. The chemical degreasing is performed at a temperature of 85° C., and the treatment duration is 30 minutes or longer.

Wherein the activation with acid wash is performed with 15 wt % HCl at 45° C.

Wherein the chemical precipitation operation is as follows: according to the surface area of the stainless steel plate, prepare palladium chloride at 2-5 g per 1 m², which is dissolved with 31 wt % HCl and then poured into 95 liters of pure water. To the solution is added 300 g of citric acid, and ammonia water is added to adjust the pH to 8-9. Warm the solution and control the temperature at 65° C. Place the stainless steel plate into the above solution. Then, hydrazine hydrate N₂H₄.H₂0 is slowly added to the solution. The total amount of hydrazine hydrate added is 100 ml and is evenly added in 2 hours. After addition, the solution is maintained at 65° C. After 1 more hour, the precipitation reaction is complete.

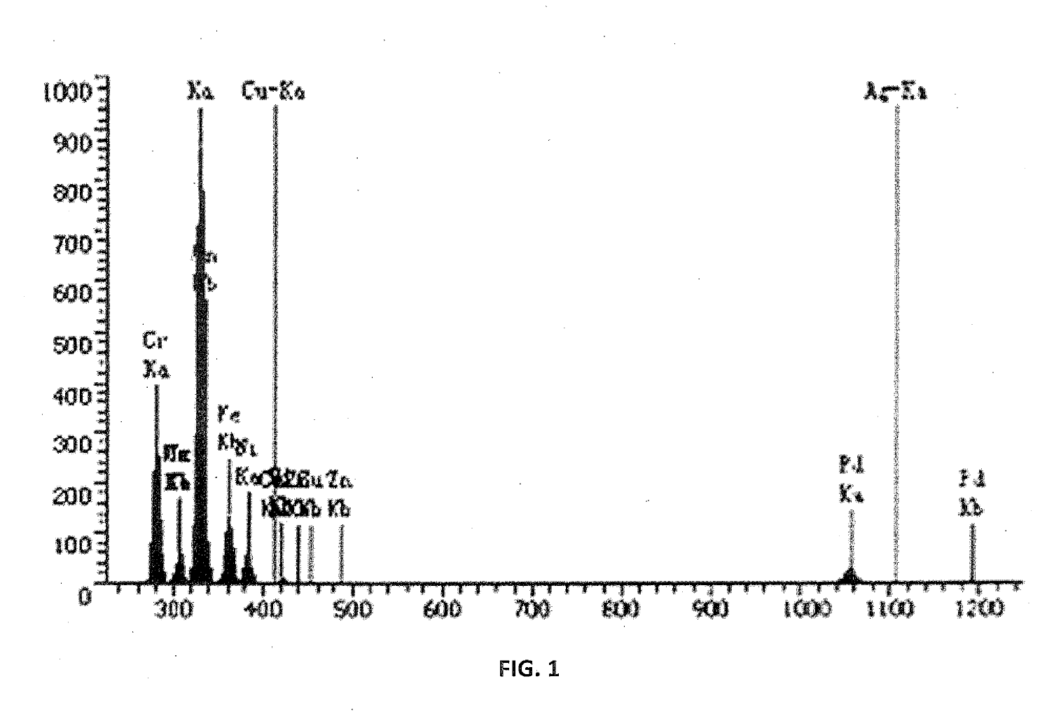

As shown in FIG. 1, X-ray fluorescence analysis of the stainless steel sample after the treatment of Example 1 revealed that there is a 0.23 μm layer of palladium evenly distributed on the surface.

### Example 2

### Preparation of Palladium Silver Catalyst

Clean a stainless steel plate having a surface area of 1 m² with tap water, followed with chemical treatments to degrease, tap water rinse, activation by washing with an acid, and then wash with pure water. Pre-treat the stainless steel surface with nickel plating (if the adhesion of palladium-silver on the stainless steel surface is sufficient for the intended use, then this pre-treatment step may be omitted). Using a chemical precipitation method, make palladium-silver alloy evenly adhere to the surface of the stainless steel. Then, it is washed with tap water and dried to obtain a palladium-silver catalyst.

Wherein the chemical used in degreasing has the following compositions (wt %): 4 wt % NaOH, 4 wt % Na₃P0₄, 3 wt % Na₂C0₃, and water makes up the remaining of 100%. The chemical degreasing is performed at a temperature of 85° C., and the treatment duration is 30 minutes or longer.

Wherein the activation with acid wash is performed with 15 wt % HCl at 45° C.

Wherein the chemical precipitation operation is as follows: according to the surface area of the stainless steel plate, a working solution is prepared: in 95 liters pure water is added 200 g of citric acid, 200 g of EDTA, and 100 g of glucose. Ammonia water is used to adjust the pH value to 9-10. Before warming the solution and controlling the temperature at 65° C., prepare A and B solutions. A solution preparation: dissolve 2 g of palladium chloride with 31 wt % HCl. Add ammonia water to adjust the pH value to 11 or higher. Then, add water to make the total volume to 1000 mL and set it aside for use later. B solution preparation: dissolve 1 g of AgNO₃ in water. Add ammonia water 100 mL and then add water to make the total volume 500 mL and set it aside for use. Place the stainless steel plate into the working solution at the controlled temperature (65° C.). Add A and B solutions at a ratio of 2:1 into the working solution in an even manner. Then, 100 mL of hydrazine hydrate N₂H₄.H₂0 is slowly added over 2 hours to the solution. After addition, the solution is maintained at 65° C. After 1 more hour, the precipitation reaction is complete.

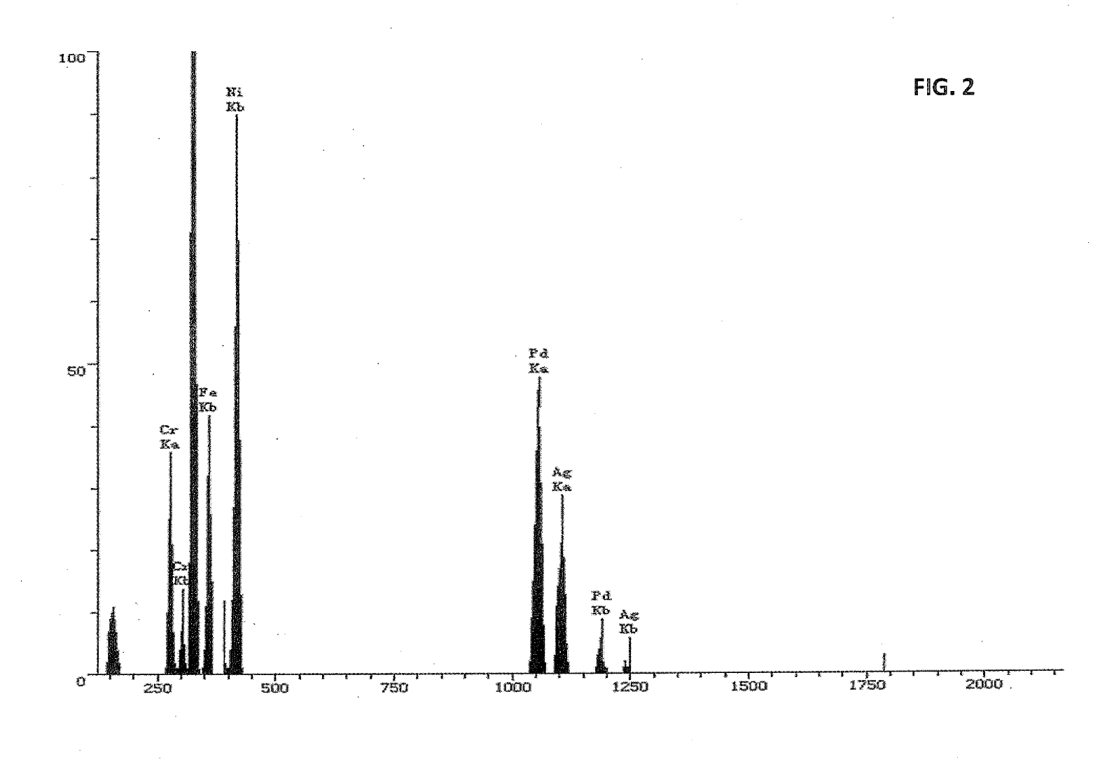

As shown in FIG. 2, X-ray fluorescence analysis of the stainless steel sample after the treatment of Example 2 revealed that there is a 0.88 μm layer of palladium-silver evenly distributed on the surface, wherein palladium accounts for 56.7% and silver accounts for 43.3%.

### Example 3

### Small Scale Test

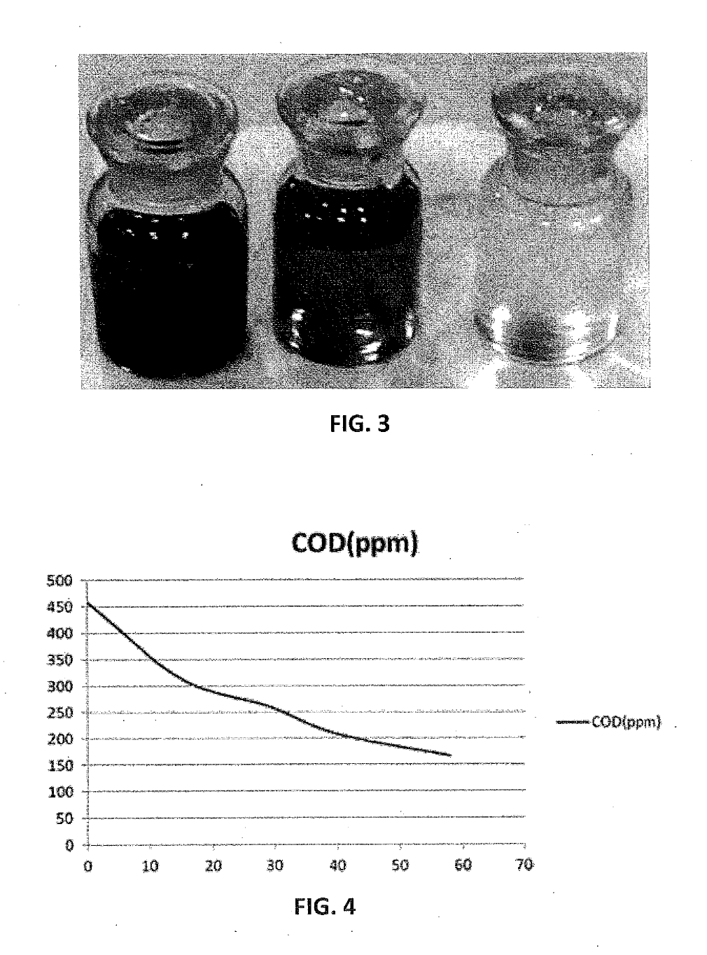

Obtain 2 liters each of wastewater from a printing and dyeing company to perform comparison decolorization tests. In container A, place 50 g of 304 stainless steel balls with a diameter of 3 mm. These balls have been treated as described in Example 2. In container B, place the same amount of the stainless steel balls that have not been treated. At the same time, using the same model of ozone generator capable of generating 20 g/hr ozone, oxygen is introduced into containers A and B that contain the wastewaters. Oxygen is introduced at a rate of 4 L/min. The oxygen gas contains about 0.9 mg/L of ozone after passing through the ozone generator. After 30 minutes, the color of wastewater in container A becomes colorless, while the color in container 13 changed from dark black to brown. Results of analyses of wastewater samples before and after the treatments are shown in FIG. 3. In the three samples before and after the treatments, the black original wastewater has a COD of 1000 mg/L, the brown water from container B after ozone treatment has a COD of 630 mg/L, and the water from container A after the ozone treatment has a COD of 55 mg/L. The treatment results are shown in FIG. 3. From left to right, these figures are: prior to the treatment, after ozone treatment (container B treatment results), and after ozone treatment (container A treatment results).

### Example 4

### Medium Scale Comparison Tests with and without Oxidation by Catalysts

Two reactors having the same dimensions are prepared with 304 stainless steel using the same techniques. Each reactor has a diameter DN of 100 mm and a length of 0.6 m. In each reactor is placed 4.5 m³ of 304 stainless steel as a filling material, wherein the filing material has a specific area of 500 m²/m³. One container is not treated (i.e., no catalyst in the reactor), while the other is treated according to the procedures described in Example 1 (i.e., the reactor contains the catalyst). The reactors are respectively connected to pumps and Venturi mixers using pipes, such that wastewater flows from the pump outlet through the Venturi mixer into the ozone-gas containing catalytic reactor before flowing out of the reactor.

Two different stainless steel reactors are used to treat PVA containing wastewater from a paper mill, via ozone circulating oxidation process. The samples from such treatments are removed for analysis. Ozone generation is by passing oxygen gas through an ozone generator, which has a capacity of producing 30 g/hr ozone. Oxygen gas is introduced at a rate of 6 L/min After passing through the ozone generator, the ozone concentration in the oxygen gas is 90 mg/L. The capacity of the circulating pump is 0.6 m³/hr. The wastewater processed is 35 L. The treatment results are shown in Table 1.

TABLE 1

| | Reactor with catalyst | | | Reactor without catalyst | | |
|---|---|---|---|---|---|---|
| | | | PVG | | | PVG |
| Time | COD | PVG | reduction | COD | PVG | Reduction |
| (min) | (ppm) | (g/L) | rate | (ppm) | (g/L) | rate |
| 0 | 437 | 1.376 | | 400 | 0.991 | |
| 40 | 208 | 0.161 | 88.29% | 399 | 0.812 | 18.10% |
| 70 | 110 | 0 | 100% | 397 | 0.709 | 28.46% |

From the results shown in TABLE 1, it can be seen that when the reactor is covered with a catalyst, the degradation rates of PVG in the wastewater by ozone is greatly enhanced. At the same time, the CDO value in the wastewater is greatly reduced. When there is no catalyst in the reactor, degradation of PVG is difficult to achieve even if one increases the ozone amounts and extends the circulation rime.

Two different stainless steel reactors are used to treat wastewater from an oximation equipment of a petrochemical plant, which mainly contains toluene, cyclohexanone oxime, and tert-butyl alcohol, for comparison tests. The samples from such treatments are removed for analysis. Ozone generation is by passing oxygen gas through an ozone generator, which has a capacity of producing 30 g/hr ozone. Oxygen gas is introduced at a rate of 6 L/min. After passing through the ozone generator, the ozone concentration in the oxygen gas is 90 mg/L. The capacity of the circulating pump is 0.5 m³/hr. The wastewater processed is 35 L. The treatment results are shown in Table 2.

TABLE 2

| Treatment | with catalyst | without catalyst |
|---|---|---|
| Time (min) | COD (ppm) | COD (ppm) |
| 0 | 330 | 326 |
| 10 | 243 | 396 |
| 20 | 205 | 365 |
| 30 | 202 | 333 |
| 40 | 134 | 365 |

After coating the interior surface of the reactor with catalyst, wastewater from oximation reaction is circulated into the reactor for treatments. Ozone is introduced for 40 minutes. During the reaction, the color of the wastewater changed, from colorless to light reddish, and again to colorless. This observation suggests that unsaturated organic matter under goes oxidation reaction, and the COD value decreases by 59.4%.

Two different stainless steel reactors are used to treat evaporation-condensation water from a petrochemical plant, which mainly contains caprolactam, cyclohexanol, cyclohexane, benzene, toluene, and ammonia nitrogen, etc. for comparison tests. The samples from such treatments are removed for analysis. Ozone generation is by passing oxygen gas through an ozone generator, which has a capacity of 30 g/hr. Oxygen gas is introduced at a rate of 6 L/min. After passing through the ozone generator, the ozone concentration in the oxygen gas is about

TABLE 3

| Treatment | with catalyst | without catalyst |
|---|---|---|
| Time (min) | COD (ppm) | COD (ppm) |
| 0 | 373 | 373 |
| 15 | 247 | 364 |
| 23 | 290 | 364 |
| 40 | 264 | 376 |
| 50 | 312 | 353 |
| 110 | 191 | 397 |

In the reactor without a catalyst, continued introduction of ozone actually increases the COD value in the wastewater. This is because the wastewater contains low-boiling substances that are difficult to oxidize, which are not easily detected using the international standard COD test. Therefore, the COD value in the original wastewater does not include these low boiling difficult to oxidize substance. Thus, the COD value is substantially lower than the actual value.

Passing ozone into the reactor with a catalyst resulted in advanced oxidation of the wastewater. The low boiling, difficult to oxidize substance is oxidized by the hydroxyl free radical to water soluble, high boiling benzoquinonyl substances, leading to an increase in the COD value. While the advanced oxidation continues, the benzoquinonyl substances continued to be oxidized, resulting in further reduction in the COD value.

### Example 5

### Treatments of Various Wastewaters (the Following Data are Results from Palladium Catalyzed Treatments)

Using the process of Example 1, a catalytic reactor made of stainless steel, having a diameter DN of 150 mm and a length of 0.8 m is produced. The reaction is filled with a filling material (the specific surface area of the filling material is 500 m²/m³). The reactor is connected with a pump and a Venturi mixer by pipes. Wastewater from the outlet of the pump passes through the Venturi mixer and mixes with ozone-containing gas before entering the catalytic reactor and then exiting the reactor. To perform the circulating treatment, 70 L of wastewater is circulated by pump at a rate of 0.8 m³/hr. The ozone generator is a model with 100 g/hr capacity. Oxygen is passed into the ozone generator at a rate of 19 L/min. After passing through the ozone generator, the ozone content in the oxygen is around 90 mg/L. The wastewaters were treated at room temperature. Sever wastewaters were treated under the same experimental conditions. The results of the wastewater treatments are shown in TABLE 4.

TABLE 4

| | | Before treatment | | After treatment | | | COD |
|---|---|---|---|---|---|---|---|
| | Treatment | Content/ | | Content/ | | Composition | removal/ |
| Compositions | time/h | ppm | COD | ppm | COD | removal/% | % |
| Paper mill | 8 | 3000.00 | 3427 | 0 | 55 | 100.00 | 98.40 |
| wastewater PVA | | | | | | | |
| Oximation | 5 | | 2330 | | 172 | | 92.62 |
| wastewater | | | | | | | |
| Evaporation | 5 | | 2700 | | 864 | | 68.00 |
| condensate | | | | | | | |
| Phenol wastewater | 3 | 549.50 | 1840 | 3.4 | 714 | 99.38 | 61.20 |
| (high concentration) | | | | | | | |
| Phenol wastewater | 3 | 208.00 | 694 | 0.08 | 142 | 99.96 | 79.54 |
| (low concentration) | | | | | | | |
| EDTA (high | 3 | 2330.47 | 1435 | 93.07 | 1427 | 96.01 | 0.56 |
| concentration) | | | | | | | |
| EDTA (low | 2.5 | 140.00 | 40 | 15.8 | | 88.71 | |
| concentration) | | | | | | | |
| Aniline | 3 | 141 | 283 | 10 | 59 | 92.20 | 79.15 |
| Dye preventive salt | 3 | 531.00 | — | 40 | | 92.47 | |
| (high concentration) | | | | | | | |
| Dye preventive salt | 1.5 | 79.00 | — | 0.14 | | 99.82 | |
| (low concentration) | | | | | | | |

### Example 6

### Various Wastewater Treatment Tests (the Following are Results from Palladium-Silver Catalyst)

Using the process of Example 2, a catalytic reactor made of stainless steel, having a diameter DN of 200 mm and a length of 1 m is produced. The reaction is filled with a filling material (the specific surface area of the filling material is 500 m²/m³). The reactor is connected with a pump and a Venturi mixer by pipes. Wastewater from the outlet of the pump passes through the Venturi mixer and mixes with ozone-containing gas before entering the catalytic reactor and then exiting the reactor. To perform the circulating treatment, 70 L of wastewater is circulated by pump at a rate of 5 m³/hr. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. Sever wastewaters were treated under the same experimental conditions. The results of the wastewater treatments are shown in TABLE 5.

TABLE 5

| | | National | Before | After | |
|---|---|---|---|---|---|
| | | Standard | treatment | treatment | COD |
| Water | Treatment | COD | COD | COD | removal |
| sample | time/h | mg/L | mg/L | mg/L | rate/% |
| Municipal | 2 | ≦60 | 138 | 60 | 56.52 |
| discharge | | | | | |
| Biochemical | 1 | ≦60 | 97 | 54 | 44.33 |
| treatment | | | | | |
| facility | | | | | |
| Discharge | | | | | |

Due to changes in the sources, municipal wastewater may interfere with the biodegradation ability in a biochemical treatment pool. Especially, wastewaters containing antibacterial agents, heavy metals, or disinfectants, etc. can reduce activity of the biological agents or kill the biological agents. As a result, the biodegradation system cannot function in a stable manner, causing the discharge after the biodegradation process to fail to meet the discharge standards.

The reason that discharges from biochemical water treatment facility of chemical plants cannot meet the discharge standard is that the chemical plant production facility continues to expand. However, due to land and investment limitations, it is impossible to expand the biochemical water treatment facility accordingly. The original biochemical treatment facility cannot meet the requirements of new wastewater quantity due to the expanded production facility. Therefore, aromatic hydrocarbons in the wastewater from the chemical plant are not completely degraded before the wastewater is discharged, thereby the discharge cannot always meet the discharge standards.

From the field tests using methods of the invention, it is clear that if the discharge outlet is equipped with treatment facility of the invention, it is possible to fully ensure that thee discharge from the plant would meet the discharge standards.

### Example 7

### Surface Water Treatment Tests (the Following Data are from Palladium Catalyzed Treatment Results)

A catalytic reactor with a diameter DN of 200 mm and a length of 1 m is prepared with stainless steel that was treated according to the procedure of Example 1. In the reactor is placed a filling material, wherein the filing material has a specific area of 500 m²/m³. The reactor is connected to a pump and a Venturi mixer using pipes, such that wastewater flows from the pump outlet through the Venturi mixer to mix with an ozone-containing gas and then enters into the catalytic reactor before the discharge flows out of the reactor. To perform the circulating treatment, 1000 L of wastewater is circulated by pump at a rate of 5 m³/hr. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. The results of the wastewater treatments are shown in TABLE 6.

TABLE 6

| | | Before | After | |
|---|---|---|---|---|
| | | treatment | treatment | COD |
| Water | Treatment | COD | COD | removal |
| sample | time/h | mg/L | mg/L | rate/% |
| Lake water | 1 | 85 | 19 | 56.52 |
| from a park | | | | |

The park has scenic lake with ornamental fish. Because it is a closed system of dead water, with an area of about 5000 m², algae growth accelerates in April every year due to increasing temperature, leading to death of fish. The sample tested for COD shows a value of 85, which meets the standards. This Example shows that embodiment of the invention can quickly degrade algae in the water and reduce COD in the water, thereby quickly restoring the production conditions in the water.

### Example 8

### MBR Tail Water Treatment Tests

A catalytic reactor with a diameter DN of 200 mm and a length of 1 m is prepared with stainless steel that was treated according to the procedure of Example 1. In the reactor is placed a filling material, wherein the filing material has a specific area of 500 m²/m³. The reactor is connected to a pump and a Venturi mixer using pipes. To perform the circulating treatment, 1000 L of wastewater is circulated by pump at a rate of 5 m³/hr. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. Several wastewaters were treated under the same experimental conditions. The results of the wastewater treatments are shown in TABLE 7.

TABLE 7

| | | Before | | After | | |
|---|---|---|---|---|---|---|
| | | treatment | | treatment | | COD |
| | Treatment | | COD | | COD | removal/ |
| Compositions | time/h | NH₃—N | mg/L | NH₃—N | mg/L | % |
| MBR treated | 2 | | 80 | | 18 | 77.5 |
| tail water | 0.5 | 3.11 | 112 | 2.44 | 58 | 48.21 |
| from membrane | 1 | 3.11 | 112 | 2.03 | 55 | 50.89 |
| bioreactor | 2 | 3.11 | 112 | 1.85 | 48 | 57.14 |
| facility of a | | | | | | |
| petrochemical | | | | | | |
| company | | | | | | |

### Example 9

### Caprolactam Biochemical Treatment Tail Water Treatment Test

The production process of caprolactam is complex. The organic matters contained in the wastewater mainly comprise benzene, toluene, cyclohexanone oxime, cyclohexanone, cyclohexane, organic acids, caprolactam, ammonia-nitrogen, etc. The wastewater also contains various peroxides and intermediates, organic solvents, etc. and is a wastewater with relatively high COD and a variety of compositions. At the same time, the various organic compositions are biological resistant or inhibitory, often leading to a B/C ratio of about 0.01. It is very difficult to have consistent biochemical treatments of these wastewaters, and the tail waters from such biochemical treatments cannot always meet the discharge standards.

Ten (10) palladium catalyst reactors with a diameter DN of 150 mm and a length of 0.8 m are prepared with stainless steel that was treated according to the procedure of Example 1. In the reactor is placed a filling material, wherein the filing material has a specific area of 500 m²/m³. The reactor is connected to a pump and a Venturi mixer using pipes.

Two tests are performed in the field tests: one with direct pass catalytic oxidation, and the other with circulation catalytic oxidation.

In field test 1, the wastewater pipe is directly connected to the inlet of the circulation pump. The pump is adjusted to 1 m³/h. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. Samples are taken from various inlets and outlets in the reaction setup for analysis and comparison. First, it was found that after catalytic oxidation, the color of the water changed substantially. The color reading decreased from 155.33 to 48.35. The water samples from the inlets and outlets have a COD of 97. BOD/COD ratio increased from 0.08 to 0.26 after the treatments. This result shows that even though COD did not change, the biochemical characteristics of the water have greatly improved.

In field test 2, place 1 m³ wastewater into a plastic container. Use flange and pipes to introduce the wastewater from the plastic container to the inlet of the pump. The pump, the Venturi mixer, and the reactor are connected by pipes. Wastewater flows from the outlet of the pump into the Venturi mixer wherein it mixes with ozone-containing gas. After passing through the reactor, the water is returned to the plastic container. The circulation pump flow rate is 8 m³/h.

All wastewaters were processed under the same experimental conditions. The treatment results are shown in TABLE 8.

TABLE 8

| | | Before | | After | | |
|---|---|---|---|---|---|---|
| | | treatment | | treatment | | COD |
| | Treatment | | COD | | COD | removal/ |
| Compositions | time/h | NH₃—N | mg/L | NH₃—N | mg/L | % |
| Tail water from | 2 | | 80 | | 18 | 77.5 |
| caprolactam | 5 | | 298 | | 55 | |
| production | 0.5 | 3.11 | 112 | 2.44 | 58 | 48.21 |
| wastewater after | 1 | 3.11 | 112 | 2.03 | 55 | 50.89 |
| biochemical | 2 | 3.11 | 112 | 1.85 | 48 | 57.14 |
| treatment | | | | | | |

### Example 10

### Paper Mill Wastewater Treatment Test

A catalytic reactor with a diameter DN of 200 mm and a length of 1 m is prepared with stainless steel that was treated according to the procedure of Example 1. In the reactor is placed a filling material, wherein the filing material has a specific area of 500 m²/m³. The reactor is connected to a pump and a Venturi mixer using pipes. To perform the circulating treatment, 500 L of wastewater is circulated by pump at a rate of 5 m³/hr. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. The results of the wastewater treatments are shown in TABLE 9.

TABLE 9

| | | | | PVA | COD |
|---|---|---|---|---|---|
| Treatment | | COD | BOD/ | removal | reduction |
| time/min. | PVA % | mg/L | COD | rate | rate/% |
| 0 | 0.3% | 3427 | 0.05 | 0 | 0 |
| 30 | 0 | 3400 | 0.34 | 100% | 0.79 |

Wastewaters from paper mills contain a large amount of PVA (polyvinyl alcohol). The BOD/COD ratio is only 0.05. This indicates that the wastewater has a poor biodegradability. It would be very difficult to use the conventional biodegradation methods to treat these wastewaters. Based on chemical analysis, PVA had been degraded to a undetectable level after 30 minute treatment. However, the COD values in the water did not change, indicating that PVA has been degraded into small molecular organic matter. Another notable indicators is that BOD/COD is greatly increased, indicating that the biodegradability of the wastewater has been greatly improved.

### Example 11

### Refinery Wastewater Treatment Tests

A palladium catalyst reactor with a diameter DN of 200 mm and a length of 1 m is prepared with stainless steel that was treated according to the procedure of Example 1. In the reactor is placed a filling material, wherein the filing material has a specific area of 500 m²/m³. The reactor is connected to a pump and a Venturi mixer using pipes. Wastewater flows from the outlet of the pump to the Venturi mixer, wherein it mixes with ozone-containing gas and then enters the catalyst reactor. After that, it flows out of the reactor via pipe. To perform the circulating treatment, 1000 L of wastewater is circulated by pump at a rate of 5 m³/hr. The ozone generator is a model with 200 g/hr capacity. Oxygen is passed into the ozone generator at a rate of 38 L/min. After passing through the ozone generator, the ozone content in the oxygen is around 90 mg/L. The wastewaters were treated at room temperature. The wastewater contains alkanes and sulfur containing compounds; is has a yellowish dirt color and a kerosene foul smell.

The experiment was continued for 58 minutes. During the process, the color of the wastewater changed as follows: yellowish dirt color→light reddish→red→light green→colorless. The smell of the wastewater changed from kerosene foul smell to odorless. During the process, a large amount of foams/bubbles appeared and then disappeared. The final treatment result is: COD decreases by 63.5%.

The COD changes during the wastewater treatment process are shown in FIG. 4.

1. A catalyst for wastewater treatment, comprising: a stainless steel carrier and a catalyst metal layer, wherein the catalyst metal layer comprises palladium evenly distributed on a surface of the stainless steel carrier.

2. The catalyst for wastewater treatment according to claim 1, wherein a thickness of the catalyst metal layer is 1 nm-5 μm.

3. The catalyst for wastewater treatment according to claim 1, wherein the catalyst metal layer further comprises silver.

4. The catalyst for wastewater treatment according to claim 3, wherein a weight of silver is 0.001%-45% of a weight of palladium.

5. The catalyst for wastewater treatment according to claim 1, wherein the catalyst metal layer is evenly adhered on the stainless steel carrier by chemical precipitation.

6. A method for treating wastewater using the catalyst according to claim 1, comprising: contacting the wastewater with the catalyst.

7. The method according to claim 6, wherein the wastewater is printing and dyeing wastewater, paper mill wastewater, slaughter house wastewater, tannery wastewater, chemical textile wastewater, food processing wastewater, petrochemical wastewater, polyvinyl alcohol-containing wastewater, colored metallurgy wastewater, coking wastewater, coal chemical wastewater, electroplating and surface treatment wastewater, oximation reaction wastewater, MBR wastewater, wastewater after biodegradation, sludge-containing wastewater after biodegradation, foul smelling wastewater, wastewater containing less than 100 ppm halogen from chemical plant, urban wastewater, wastewater from landfill seepage, wastewater from biopharmaceutical plant, wastewater containing a plasticizer and an organic agricultural chemical or toxic cyanide, river or lake water containing organic contaminants or nutrients, or industrial circulation water.

8. method according to claim 6, further comprising:
preparing a wastewater treatment container using stainless material,
preparing the catalyst by coating catalyst metal layer on an internal surface of the wastewater treatment container,
wherein the contacting the wastewater with the catalyst comprises thoroughly mixing the wastewater with ozone-containing oxygen or ozone-containing air, and then introducing the mixture into the treatment container; mixing or circulating the mixture so that the wastewater sufficiently contact the catalyst, thereby, under the action of the catalyst, the wastewater undergoes deodorization, de-colorization and degradation of organic matters, thereby due to degradation of the organic matters, it becomes easier to completely precipitate and solidify heavy metals, at the same time reducing COD in the wastewater and enhancing a ratio of BOD to COD, improving biodegradability of the wastewater.

9. The method according to claim 8, wherein the treatment container contains stainless baffles, stainless partitions, or stainless pipes, wherein a palladium metal layer is evenly distributed on a surface of these accessory parts, thereby enabling the wastewater to fully contact the catalyst to react.

10. The method of claim 6, wherein the catalyst metal layer further comprises silver.

11. The catalyst for wastewater treatment according to claim 3, wherein the palladium and silver in the catalyst metal layer exists as an alloy.

12. The catalyst for wastewater treatment according to claim 3, wherein the catalyst metal layer is formed by chemical precipitation of a solution containing palladium ion and silver ion.

13. The catalyst for wastewater treatment according to claim 3, wherein a thickness of the catalyst metal layer is 1 nm-5 μm.

14. The catalyst for wastewater treatment according to claim 1, wherein the stainless steel carrier forms a wall of a treatment container and the catalyst metal layer is on an inner surface of the treatment container.

15. The catalyst for wastewater treatment according to claim 3, wherein the stainless steel carrier forms a wall of a treatment container and the catalyst metal layer is on an inner surface of the treatment container.
